(19) United States
(12) Patent Application Publication
(10) Pub. No.: US 2011/0308063 A1
(43) Pub. Date: Dec. 22, 2011

(54) Connectors for Forming Joints Between Pieces of Finished Lumber and Methods Relating to Same

(76) Inventor: Arnold Feeleus, Winnipeg (CA)

(21) Appl. No.: 13/165,311

(22) Filed: Jun. 21, 2011

Related U.S. Application Data
(60) Provisional application No. 61/356,830, filed on Jun. 21, 2010.

(51) Int. Cl. F16B 7/00; B23P 15/00; B23P 11/00

(52) U.S. Cl. 29/525.01; 403/376; 29/428; 29/592

(57) ABSTRACT

A connector for use in forming a joint between pieces of finished lumber features interconnected sleeves having respective open ends facing in different directions at outer ends of the sleeves opposite interconnected inner ends thereof for receiving ends of respective pieces of finished lumber. Each sleeve has four sides, two of which are defined by opposing side walls that are each flexible relative to a third wall interconnecting the two opposing side walls so that the opposing side walls are movable toward and away from one another to selectively change a width of a fourth side of the sleeve to accommodate variation between different pieces of finished lumber. A fourth side wall portion on each of the opposing side walls extends toward the other side wall to present an area through which at least one fastener is passable into the respective piece of lumber.

### CROSS REFERENCE TO RELATED APPLICATIONS

This application claims benefit under 35 U.S.C. 119(e) of U.S. Provisional Patent Application Ser. No. 61/356,830, filed Jun. 21, 2010.

### FIELD OF THE INVENTION

The present invention relates to connectors or corner members for joining together pieces of standard sized finished lumber for use in a structural framework, and particularly to such a connector employing a unique design to accommodate variations among different pieces of the standard sized lumber.

### BACKGROUND OF THE INVENTION

It is known in the art to use sleeve-defining corner members to interconnect pieces of standard sized finished lumber, for example two-by-fours, for use as wooden frame members in construction of a framework. Each such corner member features a plurality of sleeves that open in different relative directions along which the frame members are to be oriented to one another and that each having a cross-section of suitable predetermined size for insertion of the lumber piece into it through its open end. When fasteners are driven into the different pieces of lumber through the respective sleeves in which they are received, the pieces of lumber are thereby interconnected and fixed relative to one another in the desired configuration.

U.S. Pat. No. 4,885,883 of Wright teaches a two-by-four corner member of this type, and U.S. Pat. No. 2,931,129 of Boniface teaches an educational constructions kit that also uses such a sleeve-type corner member to establish joints between wooden frame members. In each of these prior art patents, both incorporated herein by reference, each of the four walls of each sleeve is rigidly interconnected to each of the other three walls, giving the sleeve a fixed rectangular-volume shape of predetermined cross-sectional size and shape selected to accommodate a frame member having the prescribed dimensions and rectilinear configuration of an ideal piece of finished lumber by slightly exceeding the cross-sectional rectangular area thereof.

However, in practice, variations in shape and size exist among different pieces of finished lumber of the same intended standard dimensions, for example due to sawing variation or drying shrinkage and resulting warp (cup, twist, bow, crook). Accordingly, the aforementioned prior art corner members would need to have their sleeves sufficiently oversized to accommodate a certain expected degree of variation, but this may result in excessively play for straight pieces of lumber, which accordingly may not be as tightly held in place when fastened, potentially leading to a lack of strength in the resulting construction.

U.S. Pat. No. 4,133,151 of Burvall teaches a corner member that adopts a non-rectangular cross-sectional sleeve shape to accommodate twisting of frame members and uses a clamping member to urge the frame member into contact with the sleeve's interior.

Applicant has developed a unique alternative connector design that accommodates twist or other variations between lumber pieces in a new and different way.

### SUMMARY OF THE INVENTION

According to a first aspect of the invention there is provided a connector for use in forming a joint between pieces of finished lumber, the connector comprising a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side walls are movable toward and away from one another to selectively change a width of a fourth side of the sleeve to change a size of the respective open end to accommodate variation between different pieces of finished lumber, wherein a fourth side wall portion on each of the opposing side walls extends toward the other of the opposite side walls to present an area through which at least one fastener is passable into the respective piece of lumber when received in the respective end with the opposing side walls pressed toward one another against opposing sides of the respective piece of lumber.

Preferably each fourth side wall portion projects toward the other of the opposing sides walls by a first distance that exceeds half of a second distance by which the opposing side walls are spaced apart at the third wall.

Preferably the sleeves comprise sheet metal bent to form the walls and wall portions of the sleeves.

Preferably the sleeves are defined by an assembly of pieces, and for at least one of the sleeves, the opposing sides walls are defined by two channel shaped portions of different pieces nested at least partly one within the other with a pair of walls of the two channel shaped portions overlapping and fixed together to define the third wall of the sleeve.

Preferably the different pieces are sheet metal pieces welded together at the overlapping pair of walls of the two channel shaped portions.

In preparation for use, the connector is obtained in combination with threaded fasteners driveable through the wall portions of each sleeve with the side walls thereof pressed toward one another against opposing sides of the respective pieces of lumber to fasten the connector thereto.

According to a second aspect of the invention there is provided a method of producing a connector for forming a joint between pieces of finished lumber, the method comprising:

forming a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side walls are movable toward and away from one another to change a width of a fourth side of the sleeve, a fourth side wall portion on each of the opposing side walls extending toward the other of the opposite side walls to present an area through which at least one fastener is passable; and

leaving the fourth side wall portions unfastened with one another to retain movability of the opposing side walls toward and away from another by an end-user of the connector;

whereby a size of the respective open end each sleeve is adjustable by an end user of the connector by adjusting the width of the fourth side thereof to accommodate variation between different pieces of finished lumber during placement of the ends of respective pieces of lumber into the respective outer ends of the sleeves for fastening of each sleeve to the respective piece of lumber through the fourth side wall portions of the sleeve with the opposing side walls of the sleeve pressed toward one another against opposing sides of the respective piece of lumber.

According to a third aspect of the invention there is provided a method for forming a joint between pieces of finished lumber, the method comprising:

obtaining a connector comprising a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side walls are movable toward and away from one another to change a width of a fourth side of the sleeve, a fourth side wall portion on each of the opposing side walls extending toward the other of the opposite side walls to present an area through which at least one fastener is passable; and

for each sleeve:
sliding an end of a respective piece of lumber into said sleeve through the outer end thereof;
forcing the opposing side walls of said sleeve toward one another against opposing side walls of the respective piece of lumber; and
with the opposing side walls of said sleeve held against the opposing sides of the respective piece of lumber, fastening the fourth side wall portions of said sleeve to the respective piece of lumber.

Preferably fastening the fourth side wall portions comprises driving a fastener through an overlap of said side wall portions and into the respective piece of lumber.

Preferably each sleeve is fastened to the respective piece of lumber only at the fourth side of said sleeve.

Preferably, for at least one of the sleeves, placing the end of the respective piece of lumber into said one of the sleeves comprises spreading the opposing side walls of the sleeve apart to accommodate the end of the respective piece of lumber.

### BRIEF DESCRIPTION OF THE DRAWINGS

In the accompanying drawings, which illustrate exemplary embodiments of the present invention:

FIG. 1 is a perspective view of a table frame structure schematically showing use of finished lumber connectors of the present invention to form joints between linear frame members.

FIG. 2 is a perspective view of a storage rack frame structure schematically showing use of finished lumber connectors of the present invention to form joints between linear frame members.

FIG. 3 is an exploded perspective view of a top-corner type connector.

FIG. 4 is an exploded perspective view of a lower-center type connector.

FIG. 5 is an exploded perspective view of a lower-corner type connector.

FIG. 6 is an exploded perspective view of a top-center type connector.

### DETAILED DESCRIPTION

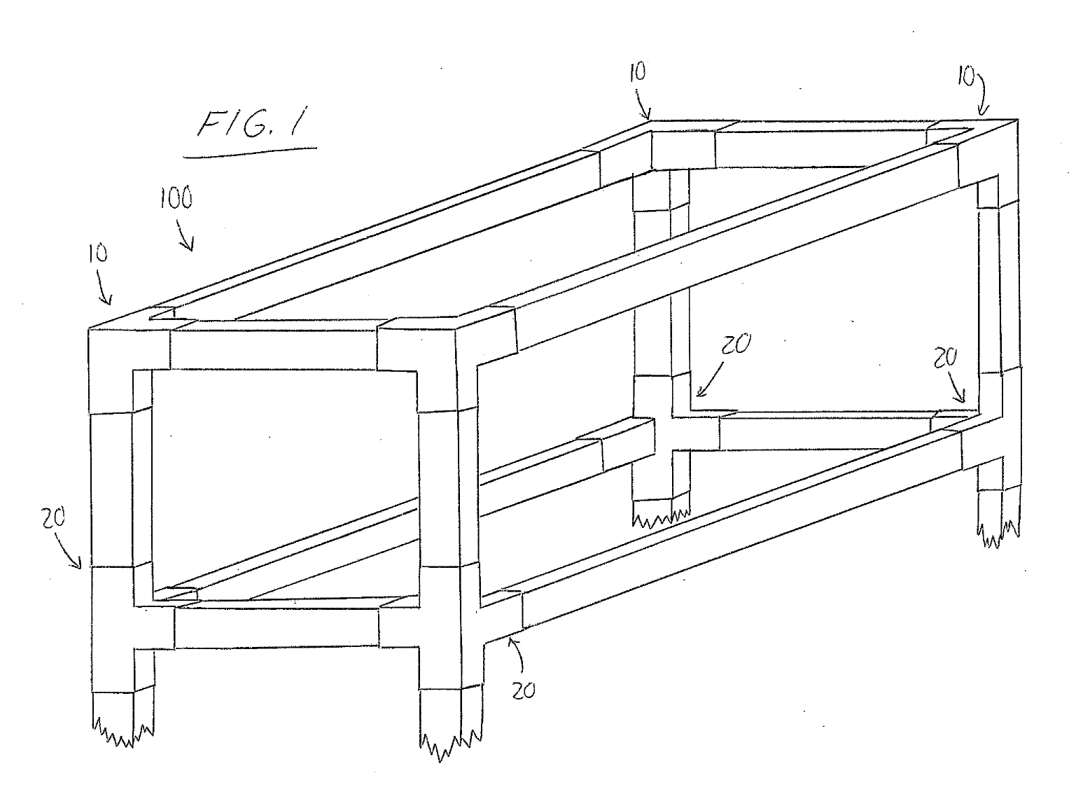

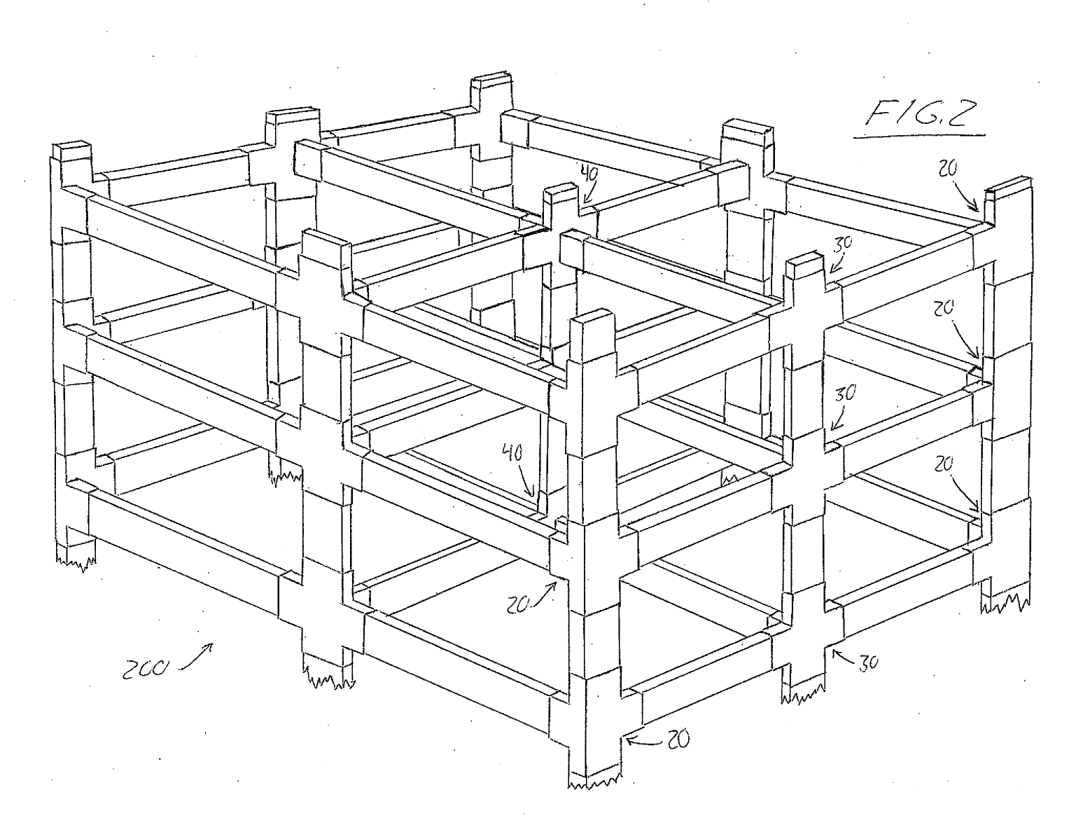

FIGS. 1 and 2 show different framework structures produced using standard two-by-four lumber frame members and connectors of the present invention to each joint between the different frame members.

FIG. 1 shows a relatively simple frame 100 that is rectangular in plan and completely open inside its rectangular perimeter. This frame may be employed as a table support structure atop which a suitable tabletop or flat work surface can be mounted to complete the construction and form a table or workbench. The frame features four three-way top corner connectors 10 that each connects three frame members together, particularly two perpendicular horizontal frame members and a single vertical frame member, and four four-way lower corner connectors 20 that each connects two other perpendicular horizontal frame members to the same vertical frame member as a corresponding one of the top corner connectors 10 at a position further down this vertical member. The resulting structure has two equally sized horizontal subassemblies of four horizontal frame members each, and upper one of which is held together at its corners by the four top corner connectors 10 and the lower one of which is held together at its corners by the four lower corner connectors 20. The four vertical frame members extend downwardly from the top corner connectors 10, through the lower corner connectors 20 to define upright supports or legs that carry the two horizontal subassemblies at respective distances above ground, atop which the bottom ends of the vertical frame members sits to define feet at the four corners of the overall structure.

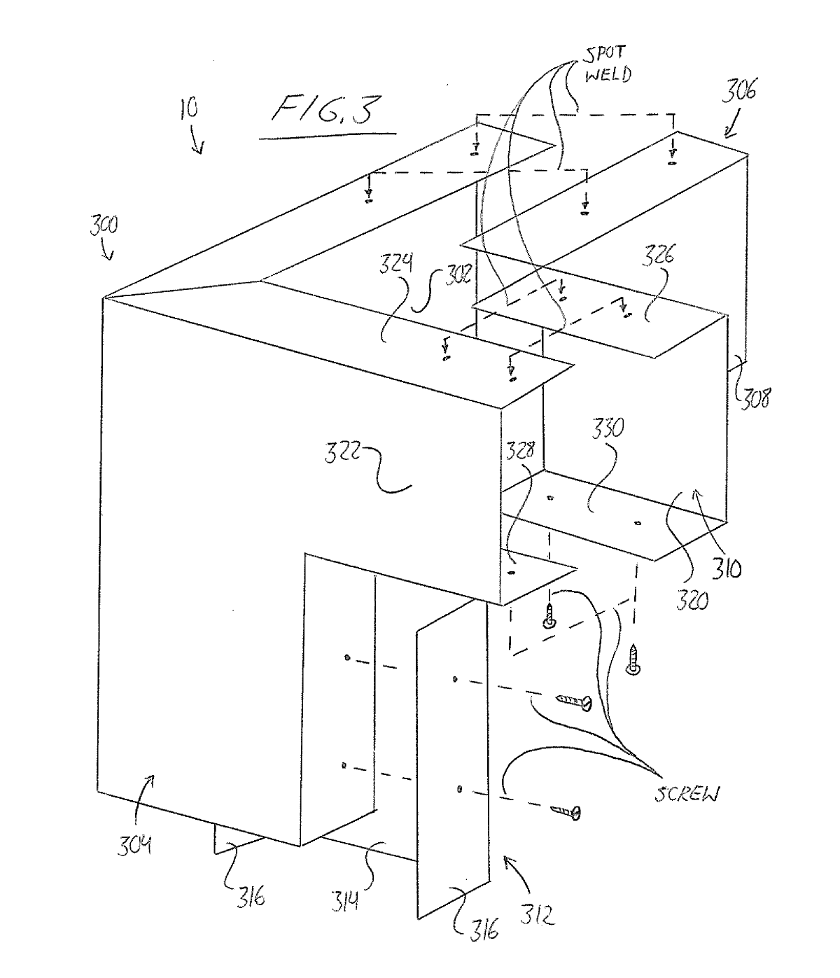

FIG. 3 shows a more complex frame 200 that is also rectangular in plan, but is larger in area and does and features a grid-like construction (as opposed to the open-center construction of FIG. 1) in order to define four quadrants of storage racking. In addition to four vertical frame members at the four corners of the structure, this structure 200 features four additional outer vertical frame members each at a central position along a respective side of its rectangular shape in plan, and a single additional center vertical frame member. On each of the corner vertical frame members, three of the lower corner connectors 20 employed in the FIG. 1 structure are used at different heights along the corner vertical frame member to connect this member to two perpendicular horizontal frame members that thus extend along respective sides of the overall structure. The uppermost one of these lower corner connectors 20 is below a top end of the respective vertical corner member and defines an uppermost connector of any kind on this corner member, thus leaving the top end of the vertical corner frame member exposed at the top of the overall structure. Accordingly, no top corner connectors are used in this structure.

Each outer side vertical frame member between two vertical corner frame members features three five-way lower center connectors 30 at respective heights aligning with the lower corner connectors 20 on the vertical corner frame members the vertical outer side frame member is aligned between. Each lower center connector 30 connects three perpendicular horizontal frame members to one another and to the outer side vertical frame member. Two parallel ones of these horizontal frame members are connected to the two respective vertical corner frame members by the two respective lower corner connectors at their ends opposite the outer side vertical frame member. A third one of the horizontal frame members coupled to the outer side vertical frame member by the particular lower center connector is arranged perpendicular to the two parallel horizontal members coupled thereto, and has its opposite end coupled to the single central vertical frame member by a respective one of three six-way central connectors 40 fixed at heights thereon matching the heights of the corner connectors 30 and the lower center connectors 30.

The resulting structure has three horizontal subassemblies at different heights along the vertical frame members that define the uprights supports of the structure. Each such subassembly has a rectangular outer perimeter divided into four smaller rectangular quadrants divided by the four horizontal frame members extending from the central vertical frame member to the four outer side frame members. Each quadrant or pair of adjacent quadrants defines a respective shelf space at which boards of material can be rested atop the horizontal frame members to form a shelf surface or at which elongated items to be stored can simply be laid over two or three parallel horizontal frame members. Each vertical frame member projects upward from each subassembly to provide a stop that prevents the shelf board or stored item from sliding off the subsassembly.

The structures of FIG. 1 and FIG. 2 are only two examples of many types of structures that can be constructed using connectors of the illustrated embodiments, which are now described in more detail as follows to establish the uniqueness of these connectors over prior art connectors usable in construction of similar framework structures.

In the finished assembled state of the structure formed using the connectors and lumber frame members, each connector has a structure similar to prior art connectors. That is, each illustrated connector features three or more hollow sleeves that are interconnected with one another and that have respective rectangular openings at outer ends of the sleeves opposite common point from which the sleeves diverge. For example, the above description of three-way, four-way, five-way and six-way connectors refers to connectors having three sleeves, four sleeves, five sleeves and six sleeves respectively, and thus each able to receive the ends of such number of boards. Each sleeve's open end faces a respective different direction away from the common point, and in the final state of the finished structure, has a basically rectangular shape closing around a respective frame member's end portion received inside it. However, the original structure of each sleeve prior to its fastening to the piece of lumber is different from the prior art, and results in a unique and advantageous way of employing the connector to form a joint with that piece of lumber. More specifically, the periphery of each sleeve is not rigidly closed around the full perimeter of the sleeve's interior, but rather has a single side in which a break is provided in the connection between side walls of the sleeve so that the side walls having this break between them can be flexed toward and away from one another to manipulate the size and shape of the open end of the sleeve.

As a result of this, the size of the sleeve opening can be increased to accommodate sliding of the end of a piece of lumber that is warped or otherwise deviated from it intended standard size into the sleeve, at which point the opposing sides of the sleeve on opposite sides of the break in the sleeve periphery can be clamped against the respective sides of the lumber to force them back toward one another and thus snugly tighten the sleeve around the lumber to provide rigid, sturdy support thereof when a fastener or fasteners are then driven into the end portion of the lumber, now nested within the sleeve, through the previously open side of the sleeve to rigidly close the sleeve are the respective piece of lumber and complete the connection of the sleeve thereto.

FIG. 3 shows an exploded view of a top corner connector 20 of the type employed in the structure of FIG. 1. The illustrated connector 20 is assembled from three pieces each formed by cutting and folding of sheet metal into the respective shape, described as follows.

A first piece 300 is formed by bending and orienting a T-shaped piece of sheet metal to bend one branch of the T-shaped piece to form a vertically planar rectangular section 302 extending perpendicularly from a vertically planar section of inverted L-shape 304 to define three rectangular braches projecting in direction perpendicular to one another, and form a pair of parallel flanges projecting perpendicularly from each one of the three perpendicular rectangular branches on opposite sides thereof from the outer end this branch back toward where this branch diverges from the others. The first piece defines an outer part of the connector that will reside at the outside of the respective corner of the structure assembled using the connector. The flanges of each pair of flanges and the vertically planar section interconnection these two flanges combine to give each of the three perpendicular branches of the piece 300 the form of a channel having squared U-shaped cross section.

A second piece 306 of the top corner connector 20 is formed by cutting, bending and orienting an elongated rectangular piece of sheet metal to form two vertically planar rectangular sections 308, 310 perpendicular to one another and form a pair of parallel horizontal flanges projecting perpendicularly from each of these rectangular sections 308, 310 on opposite sides thereof from the outer end this rectangular section back toward where this section diverges from the other. Again, each pair of flanges and the rectangular section between the two flanges of the pair cooperate to give each of the resulting two diverging branches of the piece a channel structure of squared-off U-shaped cross section.

Finally, a third piece 312 of the top corner connector 20 is formed by cutting, bending and orienting a rectangular piece of sheet metal to form a channel of squared-off U-shape in horizontal cross-section, thus having a vertically planar rectangular section 314 with a pair of flanges 316 perpendicularly this rectangular section or branch 314 in vertical planes at opposite sides thereof over the full height of the piece 312.

To assemble the top corner connector 20 during production thereof, each branch of the second piece 306 is at least partially nested inside a respective one of the two horizontal branches of the first piece 300 in an orientation with the open sides of the U-shaped channels configuration of these branches opening to one another. The upper horizontal flanges of the second piece 306 thus over- or underlie the upper horizontal flanges of the first piece 300 in a face-to-face position thereagainst. The channels of the different pieces are of equal or nearly equal width between their flanges, and so the bottom horizontal flanges of the first and second pieces likewise just over- or underlie one another. The flanges of the different pieces are likewise of equal or nearly equal width, and so the nested together channels at each of the two horizontally oriented branches cooperate to form a rectangular sleeve, and the upper flanges of the first and second pieces 300, 306 are spot welded together to assemble these two pieces together.

The third piece 312 is then added to complete the connector, by at least partially nesting the channel shapes of the third piece and the vertical branch of the first piece 300 together in a similar fashion, and likewise spot welding only two of the flanges of the two pieces together on a respective side of this vertical branch. The resulting connector thus has three sleeves each extending axially along a respective one of three perpendicular axes and having a normally rectangular cross-section.

With reference to FIG. 3, the resulting structure of a sleeve formed by the cooperation of two channel-shaped branches of the assembled pieces is now described. One side wall 320 of the sleeve is defined by the vertically planar rectangular section 310 of the second piece 306, and an opposing side wall 322 of the sleeve facing the first side wall 320 thereof is defined by the projection of the horizontal leg of the inverted L-shaped section 304 of the first piece from the vertical leg the inverted L-shape. The welded together one-over-the-other top flanges 324, 326 of the first and second pieces 300, 306 combine to define a top wall of the sleeve that interconnects the side walls 320, 322 of the sleeve and maintains spacing therebetween. The bottom flanges 328, 330 of the of the first and second pieces 300 are not welded together or otherwise fastened during production of the connector, but rather are left unfastened from one another so that, while overlapping one over the other, they are movable relative to one another by sliding one over the other under flexing of the side wails 320, 322 toward and away from one another relative to the top wall formed by the fixed-together top flanges 324, 326.

Such flexing of the side walls relative to the fixed together top flanges 324, 326 thus allows manipulation of the overlap between the two bottom flanges 328, 330 to change the width of the sleeve at the bottom thereof and thus change the overall shape and dimensions of the interior space bound by the sleeve out of this space's normally rectangular shape. Accordingly, to accommodate sliding receipt of a warped piece of lumber into the sleeve a sufficient distance, a user can pull the side walls of the sleeve away from one another or use insertion of the end of the lumber piece to force such spreading apart of the side walls, which reduces the overlap of the bottom flanges or wall portions 328, 330 and increases the width of the bottom side of the sleeve at these flanges. Once the lumber is inserted a sufficient distance, the two side walls of the sleeve are then pressed or clamped toward one another against respective opposing sides of the lumber piece, at which time at least one screw 332 is driven into the lumber through the overlapping flanges 328, 330 at the bottom of the sleeve to secure the closing of the sleeve around the lumber in a tight fitting manner to complete a secure, rigid connection of the connector to the lumber. This fastening removes the original lacking of any continual closure of the sleeve around the lumber, as the fastener now threaded through the two bottom flanges now cooperates with the spot welding of the top flanges together to form a continual closed path of the sleeve around the piece of lumber.

Each other sleeve of the connector 20 similarly has the wider opposing sides of its initial default rectangular shape defined by facing together planar portions of two pieces fastened together at two flanges of those pieces that have been placed together by nesting together of channel shaped portions of the pieces. Each sleeve is thus capable of receiving the end of a respective piece of lumber to be used as a frame member in the structure being assembled using the connector, and can accommodate such receipt despite variations among different pieces of lumber due to the initial lack of any fully intact closure of the sleeve's peripheral walls around the interior space thereof. This open structure of the sleeve gives it the flexibility required to accommodate such variations among lumber pieces of intended standard dimensions until the fastening of the connector to the lumber performs that added function of securely closing the sleeve to fix its installed shape instill rigidity to the sleeve for safe and reliable support of or connection to the lumber piece. This flexibility is balanced with the ability to tightly conform to an non-warped properly cut piece of finished lumber, as with the initially unfastened flanges at their default amount of overlap, the corresponding default rectangular shape of the sleeve can be arranged to closely adhere to the standard lumber dimensions concerned.

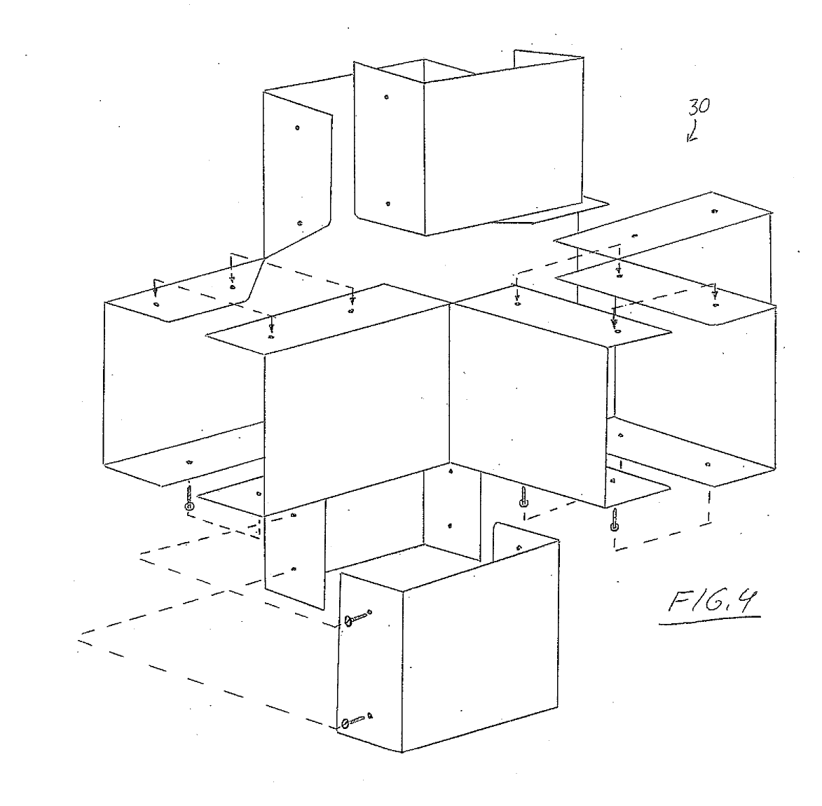

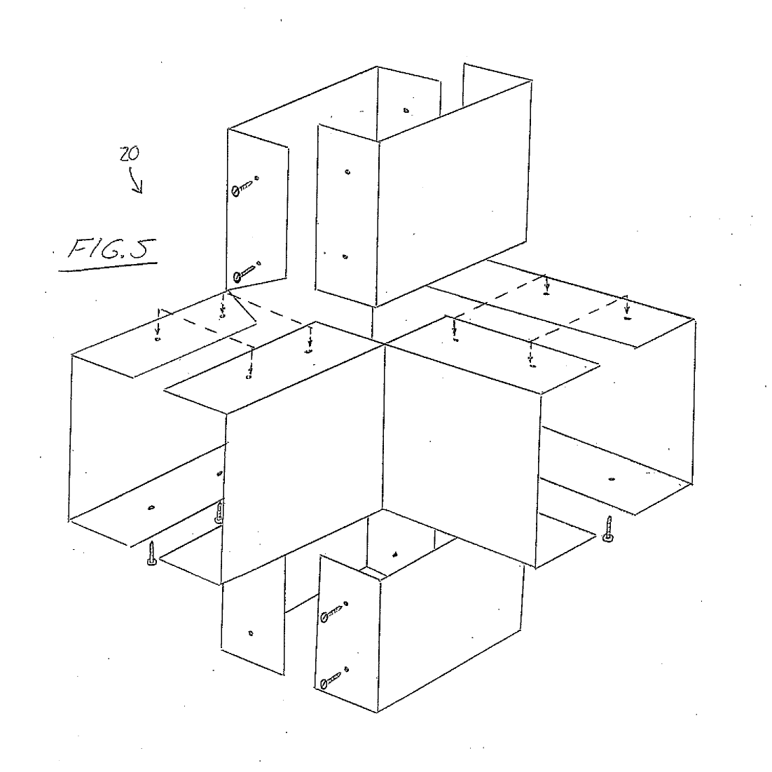

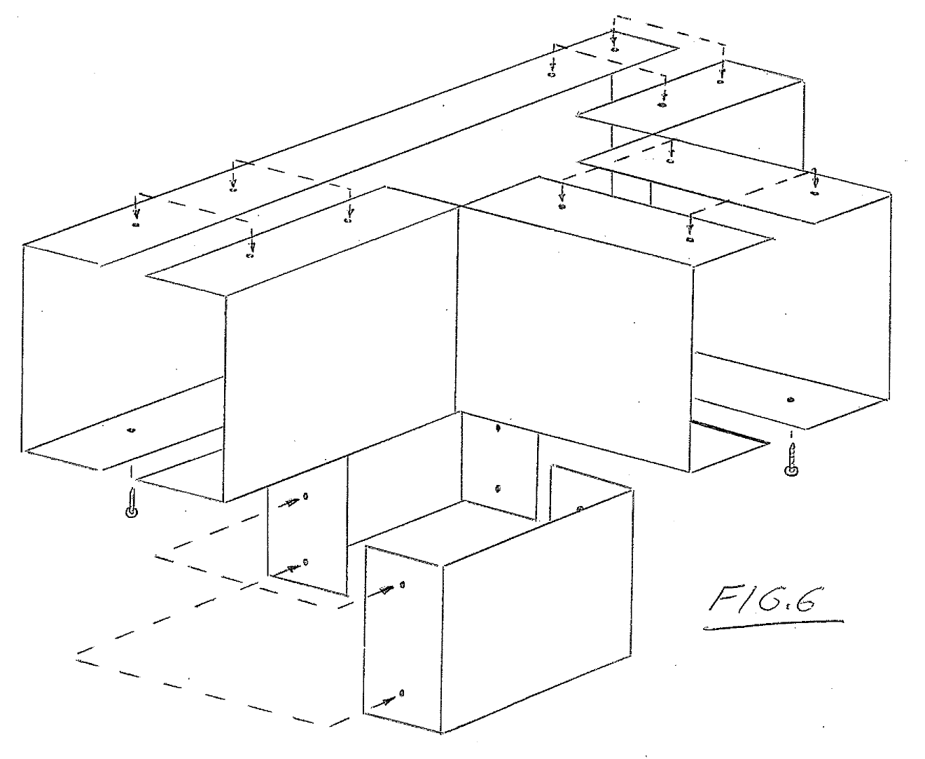

FIGS. 4 to 6 illustrate other connector assemblies and configurations for similarly interconnecting finished lumber in different positions and orientations relative to one another. Specifically, FIGS. 4 and 5 respectively show the lower corner connector and lower center connectors 20, 30 of FIG. 2, while FIG. 6 shows a top center connector having three horizontal branches with right angles between them and a single downward opening vertical branch. The connectors described herein by lower are not disposed at the very bottom of the finished structure, as they feature a downward opening vertical sleeve from which a lumber piece fitted therein extends downward. The term lower is thus used only to denote that these connectors are also not at the very top of the structure, and thus are not top connectors like the top corner connectors with no upward opening sleeve, as they feature such an upward opening vertical sleeve facing opposite the downward sleeve. It will be appreciated that the illustrated and described top corner connector may be inverted for use as a bottom corner connector in a structure where horizontal frame members are to sit on the ground or other suitable support surface.

The sheet metal construction and intended positional use of the resulting connector of each assembly of FIGS. 4 to 6 in construction of a framework should be readily appreciable to those of skill in the art from the drawings alone, and so no additional written detail is provided herein. It is understood that these additional illustrated connectors each similarly multi-piece construction using sheet metal pieces of channel-shaped arrangements and similarly result in an open-sleeve configuration that can be manipulated during use of the connector to best accommodate and fit selected lumber pieces among which at least some degree of variation will inevitably be present.

Applicant has produced and used prototype connectors of the present invention dimensioned for use with two-by-four lumber, where the flanges are dimensioned to slightly exceed the standard 1.5-inch thickness of such a wooden piece and the wall connecting between two flanges is dimensioned to slightly exceed the standard 3.5-inch width of the piece, but it will be appreciated that embodiments for other dimensional lumber may be similarly produced. Initial results have found that the connectors are able to provide significant connection strength, stability, reliability and fit even with the threaded fasteners only being used in the illustrated manner to engage the lumber only at a single side or edge thereof. Producing the connector to be pre-closed on all but one side thereof provides a desired balance between the flexibility to resize the opening between halves of each sleeve to accommodate dimensional or structural variation in standardized lumber with the ease of installation provided by only requiring fastening of the connector to the lumber at one side. Such balance between maximum flexibility and minimum fastener numbers and fastening time would not be provided by a connector initially provided to the end user in two entirely separate halves that are to be placed against the lumber from opposite sides thereof in a lumber sandwiching configuration then requiring fastening from both sides. Furthermore, it has been found that a warped piece of wood will sometimes appear to straighten to a certain degree after having been installed with tight clamping and fastening of its ends into two prototype connectors produced from 20-gauge sheet metal. Other gauges of sheet metal may instead be used while retaining sufficient flexibility before fastening to function in the manner described, yet providing sufficient rigidity and strength in the final closed-sleeve installation of the connector during construction of a framework.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A connector for use in forming a joint between pieces of finished lumber, the connector comprising a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side walls are movable toward and away from one another to selectively change a width of a fourth side of the sleeve to change a size of the respective open end to accommodate variation between different pieces of finished lumber, wherein a fourth side wall portion on each of the opposing side walls extends toward the other of the opposite side walls to present an area through which at least one fastener is passable into the respective piece of lumber when received in the respective end with the opposing side walls pressed toward one another against opposing sides of the respective piece of lumber.

2. The connector of claim 1 wherein each fourth side wall portion projects toward the other of the opposing sides walls by a first distance that exceeds half of a second distance by which the opposing side walls are spaced apart at the third wall.

3. The connector of claim 1 wherein the sleeves comprise sheet metal bent to form the walls and wall portions of the sleeves.

4. The connector of claim 1 wherein the sleeves are defined by an assembly of pieces, and for at least one of the sleeves, the opposing sides walls are defined by two channel shaped portions of different pieces nested at least partly one within the other with a pair of walls of the two channel shaped portions overlapping and fixed together to define the third wall of the sleeve.

5. The connector of claim 4 wherein the different pieces are sheet metal pieces welded together at the overlapping pair of walls of the two channel shaped portions.

6. The connector of claim 1 in combination with threaded fasteners driveable through the wall portions of each sleeve with the side walls thereof pressed toward one another against opposing sides of the respective pieces of lumber to fasten the connector thereto.

7. A method of producing a connector for forming a joint between pieces of finished lumber, the method comprising:
forming a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side walls are movable toward and away from one another to change a width of a fourth side of the sleeve, a fourth side wall portion on each of the opposing side walls extending toward the other of the opposite side walls to present an area through which at least one fastener is passable; and
leaving the fourth side wall portions unfastened with one another to retain movability of the opposing side walls toward and away from another by an end-user of the connector;
whereby a size of the respective open end each sleeve is adjustable by an end user of the connector by adjusting the width of the fourth side thereof to accommodate variation between different pieces of finished lumber during placement of the ends of respective pieces of lumber into the respective outer ends of the sleeves for fastening of each sleeve to the respective piece of lumber through the fourth side wall portions of the sleeve with the opposing side walls of the sleeve pressed toward one another against opposing sides of the respective piece of lumber.

8. A method for forming a joint between pieces of finished lumber, the method comprising:
obtaining a connector comprising a plurality of interconnected sleeves having respective open ends facing in different directions at outer ends of the sleeves opposite inner ends thereof where the sleeves are interconnected for receiving ends of respective pieces of finished lumber, each sleeve having four sides, two of which are defined by opposing side walls that are each flexible relative to a third wall interconnecting the two opposing side walls so that the opposing side wails are movable toward and away from one another to change a width of a fourth side of the sleeve, a fourth side wall portion on each of the opposing side walls extending toward the other of the opposite side walls to present an area through which at least one fastener is passable; and
for each sleeve:
sliding an end of a respective piece of lumber into said sleeve through the outer end thereof;
forcing the opposing side walls of said sleeve toward one another against opposing side walls of the respective piece of lumber; and
with the opposing side walls of said sleeve held against the opposing sides of the respective piece of lumber, fastening the fourth side wall portions of said sleeve to the respective piece of lumber.

9. The method of claim 8 wherein fastening the fourth side wall portions comprises driving a fastener through an overlap of said side wail portions and into the respective piece of lumber.

10. The method of claim 8 wherein each sleeve is fastened to the respective piece of lumber only at the fourth side of said sleeve.

11. The method of claim 8 wherein, for at least one of the sleeves, placing the end of the respective piece of lumber into said one of the sleeves comprises spreading the opposing side wails of the sleeve apart to accommodate the end of the respective piece of lumber.
